(19) United States
(12) Patent Application Publication
(10) Pub. No.: US 2005/0040576 A1
(43) Pub. Date: Feb. 24, 2005

(54) Multi-axis isolator and assembly for the same

(76) Inventors: Ernest Oxenknecht, Downers Grove, IL (US); William A. Johnson, Naperville, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/644,426

(22) Filed: Aug. 20, 2003

(51) Int. Cl. F16F 1/44; B60G 11/22

(52) U.S. Cl. 267/293

(57) ABSTRACT

A multi-axis isolator assembly comprises an upper base, a lower base having a first tubular member, first and second isolation layers, and an isolator. First and second isolation layers and isolator are disposed between the upper and lower bases. The first isolation layer and isolator substantially circumscribe the first tubular member of the lower base. The second isolation layer substantially circumscribes the isolator. This abstract is submitted with the understanding that it will not be used to interpret or limit the scope or meaning of the claims.

### TECHNICAL FIELD

The present invention relates to a multi-axis isolator and assembly. In particular, the present invention relates to a multi-axis isolator and assembly for securing a heat shield to an exhaust manifold while isolating vibrational forces from the exhaust manifold.

### BACKGROUND OF THE INVENTION

Objects attached to a vehicular engine experience vibrational forces generated by the operation of the engine. A conventional method of damping vibration, and in turn reducing noise, is with a T-shaped mount. A typical T-shaped mount includes a metal cylindrical sleeve that runs vertically the height of the mount to provide structural rigidity to the mount. A metal bolt passes through the metal sleeve for securing the mount to the engine. Various materials, including rubber or metal mesh, surround the cylindrical sleeve of the mount to assist in dampening the vibrations.

A number of problems have become apparent with the use of conventional T-shaped mounts with rubber. For example, rubber has a relatively short service life. Because of the shearing and torquing forces applied by the motor to the mount, the rubber has a tendency to collapse in a relatively short time. Moreover, rubber also has a tendency to deteriorate when it comes into contact with gasoline, oil, grease, road salt, or other chemicals and solvents present in an engine environment. Metal mesh mounts have relatively low load carrying ability in radial directions. Therefore, conventional metal mesh mounts do not sufficiently attenuate vibrations in the radial direction.

### SUMMARY OF THE INVENTION

To overcome the above identified problems and other problems associated with conventional mounting assemblies, the present invention is directed to a multi-axis isolator assembly. The multi-axis isolator assembly includes an upper base, a lower base having a first tubular member, first and second isolation layers, and an isolator. The first and second isolation layers and isolator are disposed between the upper and lower bases. The first isolation layer and isolator substantially circumscribe the first tubular member. The second isolation layer substantially circumscribes the isolator.

### BRIEF DESCRIPTION OF THE DRAWINGS

The present invention will now be described, by way of example, with reference to the accompanying drawings, in which:

FIG. 1 is a cross sectional view of a mounting assembly according to one embodiment of the present invention.

FIG. 2 is an expanded view of the mounting assembly according of FIG. 1.

FIG. 3 is a perspective view of an isolator according to an alternative embodiment of the present invention.

FIG. 4 is a cross-sectional view of a mounting assembly including the alternative isolator according to FIG. 4.

FIG. 5 is a cross-sectional view of a mounting assembly according to an alternative embodiment of the present invention.

### DESCRIPTION OF THE PREFERRED EMBODIMENT

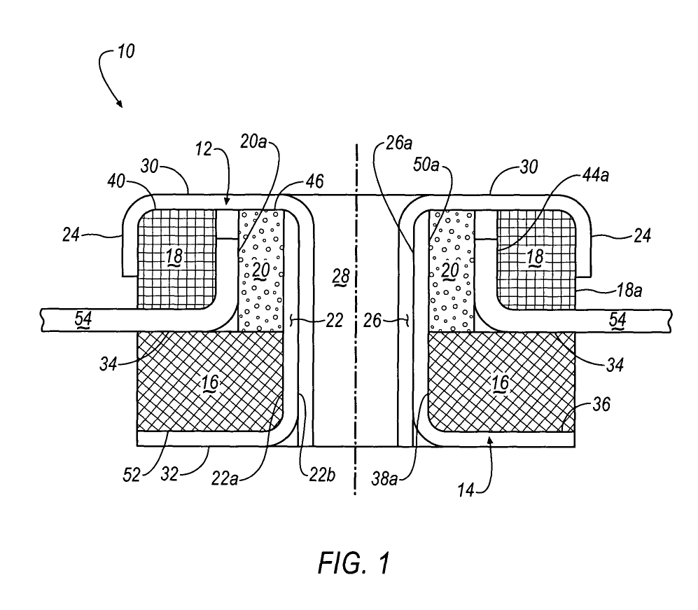

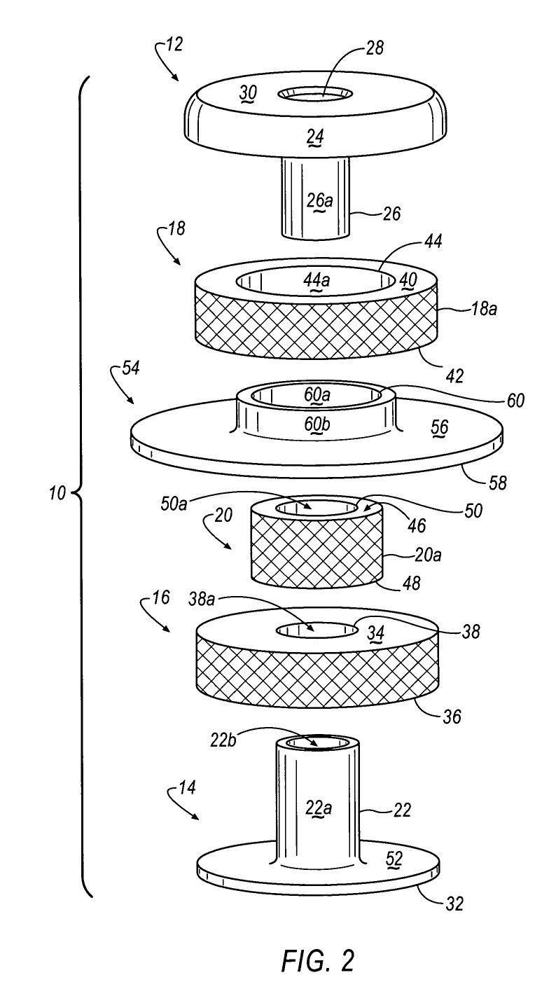

Referring to FIGS. 1 and 2, a mounting assembly 10 is shown according to one embodiment of the present invention. Mounting assembly 10 includes upper and lower bases 12, 14 respectively, first and second isolation layers 16,18 respectively, and an isolator 20. Lower base 14 has an integral first tubular member 22. Upper base 12 includes a lip 24 and an integral second tubular member 26, defining a central opening 28. Central opening 28 extends from an outer surface 30 of upper base 12 to an outer surface 32 of lower base 14.

First and second isolation layers 16, 18 and isolator 20 are disposed between upper base 12 and lower base 14 and positioned circumferentially around central opening 28. First isolation layer 16 has upper and lower surfaces 34, 36 and a cylindrical aperture 38. Aperture 38 of first isolation layer 16 extends from upper surface 34 to lower surface 36 of first isolation layer 16. Second isolation layer 18 has upper and lower surfaces 40, 42 and a cylindrical aperture 44. Aperture 44 of second isolation layer 18 extends from upper surface 40 to lower surface 42 of second isolation layer 18. Likewise, isolator 20 has upper and lower surfaces 46, 48 and a cylindrical aperture 50. Similarly, cylindrical aperture 50 extends from upper surface 46 to lower surface 48 of isolator 20.

FIG. 2 is an expanded view of mounting assembly 10 in an installed position on a mounting surface (not shown). During installation of mounting assembly 10, lower base 14 rests upon the mounting surface. First isolation layer 16 is placed on lower base 14. First tubular member 22 passes through aperture 38 of first isolation layer 16. Fully installed, lower surface 36 of first isolation layer 16 rests upon an inner surface 52 of lower base 14. Inner surface 38a of aperture 38 of first isolation layer 16 abuts outer surface 22a of first tubular member 22.

Isolator 20 is then disposed over first isolation layer 16. In the same manner as first isolation layer 16, first tubular member 22 slides through aperture 50 of isolator 20. Fully installed, lower surface 48 of isolator 20 rests upon upper surface 34 of first isolation layer 16. Additionally, inner surface 50a of aperture 50 of isolator 20 abuts outer surface 22a of first tubular member 22.

Next, a heat shield 54 is installed to the mounting assembly 10. Heat shield 54 includes upper and lower surfaces 56, 58 and a lipped aperture 60. Tubular member 22 of lower base 14 slides through lipped aperture 60 of heat shield 54. Additionally, isolator 20 passes through lipped aperture 60 of heat shield 54. Fully installed, lower surface 58 of heat shield 54 rests upon upper surface 34 of first isolation layer 16. Inner surface 60a of the lipped aperture 60 of heat shield 54 abuts outer surface 20a of isolator 20.

Next, second isolation layer 18 is placed over heat shield 54. Second isolation layer 18 slides past first tubular member 22. Lower surface 42 of second isolation layer 18 rests upon upper surface 56 of heat shield 54. Inner surface 44a of aperture 44 of second isolation layer 18 abuts outer surface 60b of lipped aperture 60 of heat shield 54. Fully installed, lipped aperture 60 of heat shield 54 is disposed between isolator 20 and second isolation layer 18.

Finally, upper base 12 is placed over second isolation layer 18. Second tubular member 26 slides into first tubular member 22, such that outer surface 26a of second tubular member 26 abuts inner surface 22b of first tubular member 22. In a fully installed position, second tubular member 26 extends to the mounting surface and upper base 12 rests upon upper surface 40 of second isolation layer 18. Lip 24 of upper base 12 abuts outer surface 18a of second isolation layer 18, such that second isolation layer 18 is nestled between heat shield 54 and lip 24 of upper base 12.

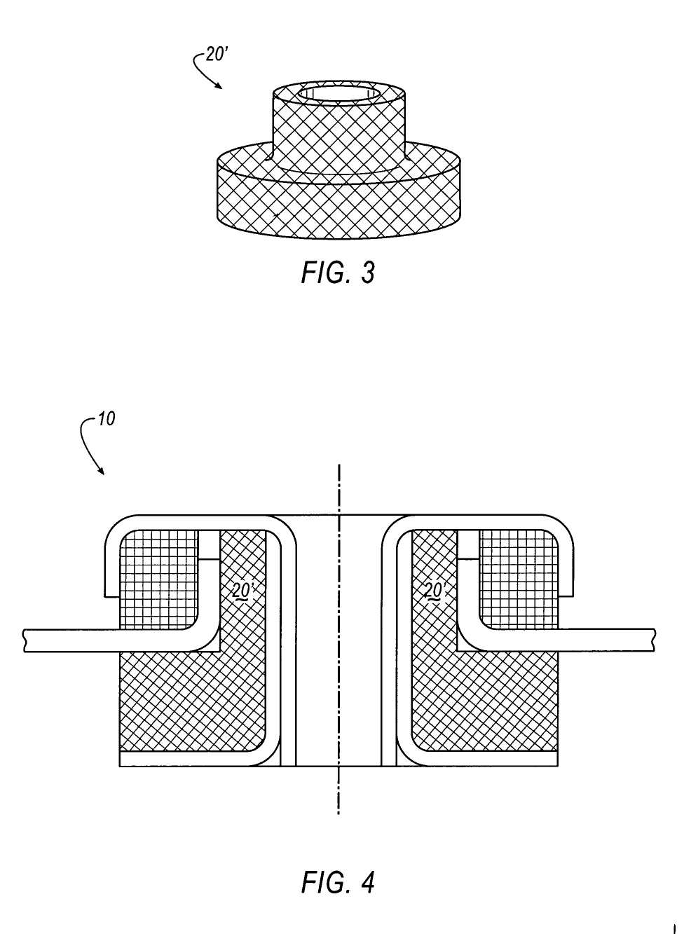

Referring to FIGS. 3 and 4, first isolation layer 16 and isolator 20 are shown according to the alternative embodiment of the present invention. First isolation layer 16 and isolator 20 are constructed as a single isolator 20′. Unitary isolator 20′ provides additional advantages over first isolation layer 16 and isolator 20. For instance, unitary isolator 20′ results in a reduced number of parts for mounting assembly 10. Moreover, the reduced number of parts results in easier assembly of mounting assembly 10.

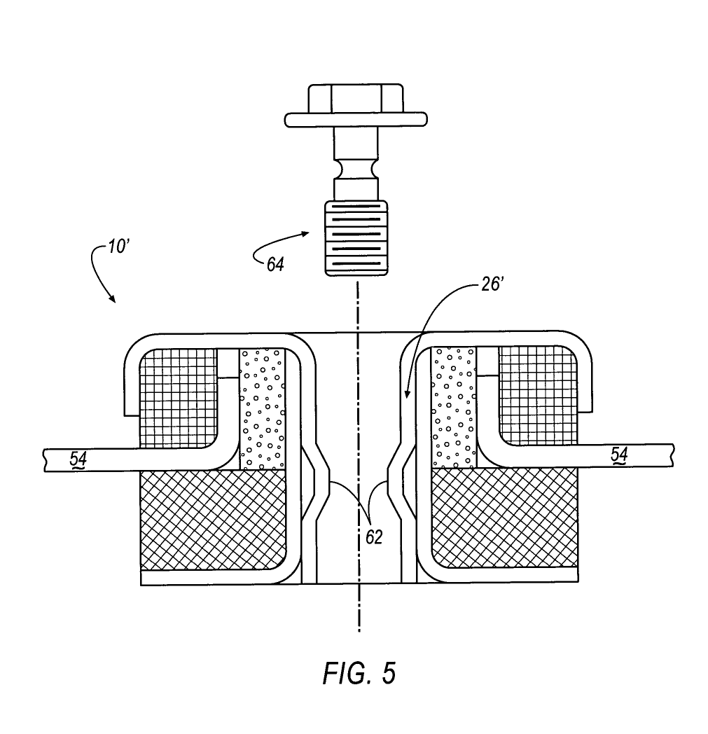

FIG. 5 depicts an alternative embodiment of the present invention. Mounting assembly 10′ substantially incorporates the features of mounting assembly 10 of FIGS. 1 and 2. However, second tubular member 26′ of mounting assembly 10′ contains a crimp or dimple 62 for engaging a fastener 64. Dimple 62 may be positioned anywhere within central opening 28′ of second tubular member 26′, so long as dimple 62 engages fastener 64. Further, while the present invention contains a dimple 62, it is appreciated that any form of indentation may be created on second tubular member 26, so long as the indentation engages fastener 64. Fastener 64, in turn, secures heat shield 54 to the mounting surface. Any conventional fastener 64 known in the art for securing a heat shield 54 to a mounting surface may be utilized.

Referring to FIGS. 1-5, first and second isolation layers 16, 18, and isolator 20 are made from a wire mesh material. The wire mesh material allows first and second isolation layers 16, 18 and the isolator 20 to work in high temperature environments. First and second isolation layers 16, 18 and isolator 20 cooperate with the mass of heat shield 54 to act as a tuned system. The spring rate of the first and second isolation layers 16, 18 and isolator 20, along with the mass of heat shield 54, determine the natural frequency of the tuned system. The result is any forced vibrations from the mounting surface, above the natural frequency, are not transmitted by first and second isolation layer 16, 18 and isolator 20 to heat shield 54. Heat shield 54 is protected from vibrations of the mounting surface. Isolation layers 16, 18 and isolator 20 or 20′ of the present invention provide many advantages over conventional mounting assemblies. Mounting assembly 10 and 10′ improves isolation of vibrations in the radial direction of isolator 20. This is a benefit when the axis of isolator 20 cannot be attached in an orientation parallel to the primary vibrations of the mounting surface. Furthermore, non-primary vibrations commonly may occur in different axis. Isolator 20 can also prevent non-primary vibrations from being transmitted to heat shield 54. It can be appreciated that unitary isolator 20′ can replace first isolation layer 16 and isolator 20 without compromising the performance of mounting assembly 10 or 10′ while obtaining the same benefits and improvements.

Upper and lower bases 12, 14 may be stamped, turned metal, powdered metal or any other suitable material for high temperature environments. Lower base 14 acts as a base washer for mounting assembly 10. Therefore, there is no need for additional base washers to be placed on the mounting surface before attaching the mounting assembly 10. The present invention results in a mounting assembly 10 having fewer parts than conventional mounting assemblies. Additionally, having first and second tubular members 22, 26 integral with upper and lower bases 12, 14, respectively, eliminates the need for a separate inner collar from the base washer, as present in conventional mounting assemblies. The fewer parts of the present invention not only result in cost savings, but also increase the ease of assembling the mounting assembly 10. Furthermore, first and second tubular members 22, 26 act as load bearing columns for first and second isolation layers 16, 18 and isolator 20.

Lipped end 24 of upper base 12 provides greater surface area for upper base 12 to contact second isolation layer 18. This allows second isolation layer 18 to assist isolator 20 with isolating radial vibrations. Therefore, the load on isolator 20 is lessened, resulting in a longer life cycle of isolator 20 and mounting assembly 10. Similarly, lipped aperture 60 of heat shield 54 provides greater surface area for second isolation layer 18 and isolator 20 to contact heat shield 54. The increased contact results in isolation layer 18 and isolator 20 being able to isolate more vibrational forces from heat shield 54.

While the present invention is directed towards a mounting assembly 10 or 10′ for a heat shield 54 of an exhaust manifold (not shown), it can be appreciated that the present invention is not limited in application to a heat shield for an exhaust manifold. The present invention can be practiced in any environment that requires isolating vibrational forces from a vibrational surface. For example, mounting assembly 10 or 10′ can be used in the field of household electrical appliances or heavy machinery.

While the invention has been specifically described in connection with certain specific embodiments thereof, it is to be understood that this is by way of illustration and not of limitation, and the scope of the appended claims should be construed as broadly as the prior art will permit.

1. A mounting assembly comprising:
an upper base;
a lower base having a first tubular member;
first and second axial isolation layers; and
an isolator;
wherein said first and second isolation layers and said isolator are disposed between said upper and lower bases, wherein said first isolation layer and said isolator substantially circumscribe said first tubular member of said lower base and said second isolation layer substantially circumscribes said isolators
wherein said upper base is adjacent and in communication with said second axial isolation layer and said isolator,
wherein said lower base is adjacent and in communication with said first axial isolation layer; and
wherein said mounting assembly includes an annular-gap adapted for receiving a tubular portion of a mounting surface.

2. A mounting assembly according to claim 1, wherein said first and second isolation layers and said isolator each have an aperture, wherein said apertures substantially circumscribe said first tubular member.

3. A mounting assembly according to claim 1, wherein said upper base further includes a second tubular member, and wherein said second tubular member defines a central opening.

4. A mounting assembly according to claim 3, wherein said second tubular member has a smaller diameter than said first tubular member, such that said second tubular member slidingly engages into said first tubular member.

5. A mounting assembly according to claim 3, wherein said second tubular member has a dimple for engaging a fastener.

6. A mounting assembly according to claim 1, wherein said upper base includes a lip, said lip abuts said second isolation layer.

7. A mounting assembly according to claim 1, wherein said isolator and said first isolation layer are constructed as one integral piece.

8. A mounting assembly according to claim 1, wherein said first and second isolation layers and said isolator are constructed of a wire mesh material.

9. (Canceled)

10. (Canceled)

11. A mounting assembly according to claims 1, wherein said second tubular member has a smaller diameter than said first tubular member, such that said second tubular member slidingly engages into said first tubular member.

12. (Canceled)

13. (Canceled)

14. An assembly for mounting an object to a mounting surface comprising:
a load absorbing member defining a central opening, said member having an inner surface, an outer surface, and an upper base including a lip;
first and second isolation layers disposed in a region defined by said outer surface of said load absorbing member, each of said isolation layers including inner surfaces that substantially circumscribe said outer surface of said member; and
an isolator disposed in a region defined by said inner surface of said second isolation layer and said outer surface of said member, said isolator having an outer surface spaced apart from the inner surface of said second isolation layer to form an annular gap for receiving a tubular portion of the mounting surface.

15. An assembly as in claim 14, wherein said load absorbing member includes a lower base.

16. An assembly as in claim 14, wherein said lower base includes a first tubular member, wherein said upper base includes a second tubular member, and wherein said second tubular member slidingly engages said first tubular member, defining said central opening.

17. An assembly as in claim 16, wherein said second tubular member includes a dimple for engaging a fastener.

18. A mounting assembly according to claim 14, wherein said isolator and said first isolation layer are constructed as an integral piece.

19. An assembly as in claim 14, wherein said first and second isolation layers and said isolator are made from a wire mesh material.

20. A mounting assembly comprising:
a lower base including a first tubular member;
an upper base including a second tubular member slidingly engaging said first tubular member, said first tubular member having a dimple for engaging a fastener;
a first axial isolation layer disposed adjacent said lower base;
a second axial isolation layer adjacent said upper base; and
an isolator adjacent said upper base and in communication with said first isolation layer, said isolator having an outer surface spaced apart from an inner surface of said second axial isolation layer to form an annular gap for receiving a tubular portion of a mounting surface.

21. A mounting assembly according to claim 20, wherein said isolator and said first axial isolation layer are formed as one integral piece.

22. A mounting assembly according to claim 20, wherein said first axial isolation layer, said second axial isolation layer, and said isolator each have an aperture, said apertures substantially circumscribes said first tubular member.

22. A mounting assembly according to claim 20, wherein at least one of said first axial isolation layer, said second axial isolation layer, and said isolator is formed of a wire mesh material.
